(19) United States
(12) Patent Application Publication
(10) Pub. No.: US 2013/0199171 A1
(43) Pub. Date: Aug. 8, 2013

(54) Wave Power Assembly

(71) Applicant: Christoph Hendrik Brink, Karino (ZA)

(72) Inventor: Christoph Hendrik Brink, Karino (ZA)

(73) Assignee: MAHALA POWER CO. LTD., Karino (ZA)

(21) Appl. No.: 13/701,860

(22) PCT Filed: Jun. 30, 2011
(86) PCT No.: PCT/IB2011/052876

§ 371 Date: Mar. 6, 2013

(30) Foreign Application Priority Data
Jul. 1, 2010 (ZA) 2010/04633

(51) Int. Cl. F03B 13/14

(52) U.S. Cl. CPC F03B 13/14
USPC 60/507

(57) ABSTRACT

A wave power buoy assembly for underwater installation having a tensile member with an operatively upper end and an operatively lower end, a buoy attached to the upper end of the tensile member and a friction coupling attached to the lower end of the tensile member for installing the tensile member to a driveshaft of an electrical generator, such that when installed on the driveshaft, the frictional coupler rotationally engages the shaft upon tensioning of the tensile member and disengages the driveshaft upon relief of tension of the tensile member.

THIS INVENTION relates to a wave power assembly. In particular, the invention relates to a wave power buoy assembly for capturing the energy of waves. The invention also relates to a wave power buoy installation including the buoy assembly.

The invention is expected to be advantageously applicable to capturing of wave power at sea. Accordingly, such applications should particularly, but not exclusively, be borne in mind when considering this specification.

### BACKGROUND OF THE INVENTION

The concept of generating electricity by capturing wave power is well-known as an alternative to generating electrical power from fossil fuels. Wave power devices may be classified according to their wave energy capture mechanisms and by their power take-off systems. Amongst others, the capture mechanisms include point absorbers or buoys and the take-off systems may include linear electrical generators.

Wave power systems of the kind are prone to complexities of installation and maintenance of a variety and high number of components. Compared with conventional power generation systems, the total cost of electricity from wave power systems is high, due in part to component and installation costs.

The inventor has identified a need for a simplified buoy assembly for capturing wave energy and transmitting of the energy to a power take-off system, the assembly having a minimum number of components. The present invention provides a mechanism that aims to overcome at least some of the drawbacks associated with conventional wave power systems.

### SUMMARY OF THE INVENTION

In accordance with the invention, broadly, there is provided a wave power buoy assembly for underwater installation which includes a tensile member having an operatively upper end and an operatively lower end, a buoy attached to the upper end of the tensile member and a friction coupling attached to the lower end of the tensile member for installing the tensile member to a driveshaft of an electrical generator, for example a linear electrical generator, such that when installed on the driveshaft, the frictional coupler rotationally engages the shaft upon tensioning of the tensile member and disengages the driveshaft upon relief of tension of the tensile member.

Thus, in use and with the frictional coupler of the wave power buoy assembly installed on an underwater driveshaft installation, for example a coastline sea installation, the tensile member is substantially vertically suspended from the buoy that floats at sea level. Rising of the water level as a result of either tidal or wave rising causes the buoy to rise and tension the tensile member. The tensioning exerts a force on the frictional coupler connected to the lower end of the tensile member, the force acting to frictionally engage the coupler with the driveshaft thus rotating the driveshaft in one direction. Conversely, as the water level falls, the buoy is lowered, resulting in relaxing of the tensile member and corresponding rotational disengagement of the frictional coupler with the driveshaft in an opposite direction thereby returning the coupling to an unstressed, rested position in readiness of a following cycle of rotational engagement and disengagement.

More particularly and according to one aspect of the invention, there is provided a wave power buoy assembly which includes:

a tensile member having operatively upper and lower ends;

a buoy attached to the operatively upper end of the member;

a torque lever attached to the operatively lower end of the member; and

a friction coupling defining a pivot and rigidly connected to the torque lever for annular installation of the coupling on the driveshaft of the electrical generator.

In one embodiment of the buoy assembly, the friction coupling may include a strap wrench, the strap wrench including a strap, a claw shaped and dimensioned to mount on the driveshaft and at least one rigid bar retainer, the bar retainer defining the torque lever. In this embodiment it should be appreciated that the friction coupling and torque lever are integrally provided by looping ends of the strap around the driveshaft and opposing threading the strap through the at least one bar retainer in conventional strap wrench assembly style. The strap wrench may include a ratchet.

In another embodiment the torque lever may be a rigid elongate lever attached at one end thereof to the operatively lower end of the tensile member and defining a pivot-end connected to the pivot of the friction coupling.

The friction coupling may include an annular clutch for installing on the driveshaft, the clutch providing the pivot and the clutch rigidly connected to the torque lever at the pivot-end of the rigid elongate lever. Particularly, the clutch may be a one-way free wheeling clutch or so-called overrunning clutch that allows engagement of the driveshaft and rotation thereof in one direction only, i.e. in use upon rising of the buoy and tensioning of the tensile member, and disengagement and slipping of the clutch in an opposite direction, i.e. upon use and relaxation of the tensile member by lowering of the accompanying buoy.

The one-way free wheeling clutch may include, but is not limited to, any one of a ramp and roller, sprag and drawn cup roller type clutch.

The tensile member may include any one of a cable, string or the like.

According to another aspect of the invention there is provided a wave power buoy installation which includes:

an electrical generator driveshaft installed substantially horizontally at least partly underwater; and

a plurality of buoy assemblies as hereinbefore described installed on the driveshaft in a buoy assembly array.

The buoy installation may include a power take-off system connected to the driveshaft. Advantageously, the driveshaft may be installed on a purpose-designed mounting rig.

Preferably, the array of assemblies may include a high number of buoy assemblies to take advantage of cumulative rotation of the driveshaft by the frictional couplings of the assemblies in use. It is appreciated that, in use, varying wave or tidal conditions will cause those assemblies that are under tension as a result of their buoys being lifted by the water level to rotate the driveshaft, whilst those assemblies of which the buoys are lowered and of which the tensile members are in a relaxed state do not transfer any rotational force to the driveshaft. As a result, the driveshaft may be constantly rotated in one direction by cumulative addition of the rotational forces of buoy assemblies acting under operatively vertical tension.

The invention will now be described by way of non-limiting example with reference to the accompanying diagrammatic drawings.

The invention is now described, by way of non-limiting example, with reference to the accompanying diagrammatic drawings.

### DRAWINGS

In the drawings,

FIG. 1 illustrates, diagrammatically and in side view, a wave buoy assembly in use in accordance with one aspect of the invention.

FIG. 2 diagrammatically shows a three-dimensional view of a wave buoy assembly in use and installed on a driveshaft in accordance with the invention.

FIG. 3 shows a side view of a wave buoy assembly installation in accordance with another aspect of the invention.

Unless otherwise indicated, like reference numerals denote like parts of the invention.

### DETAILED DESCRIPTION OF THE INVENTION

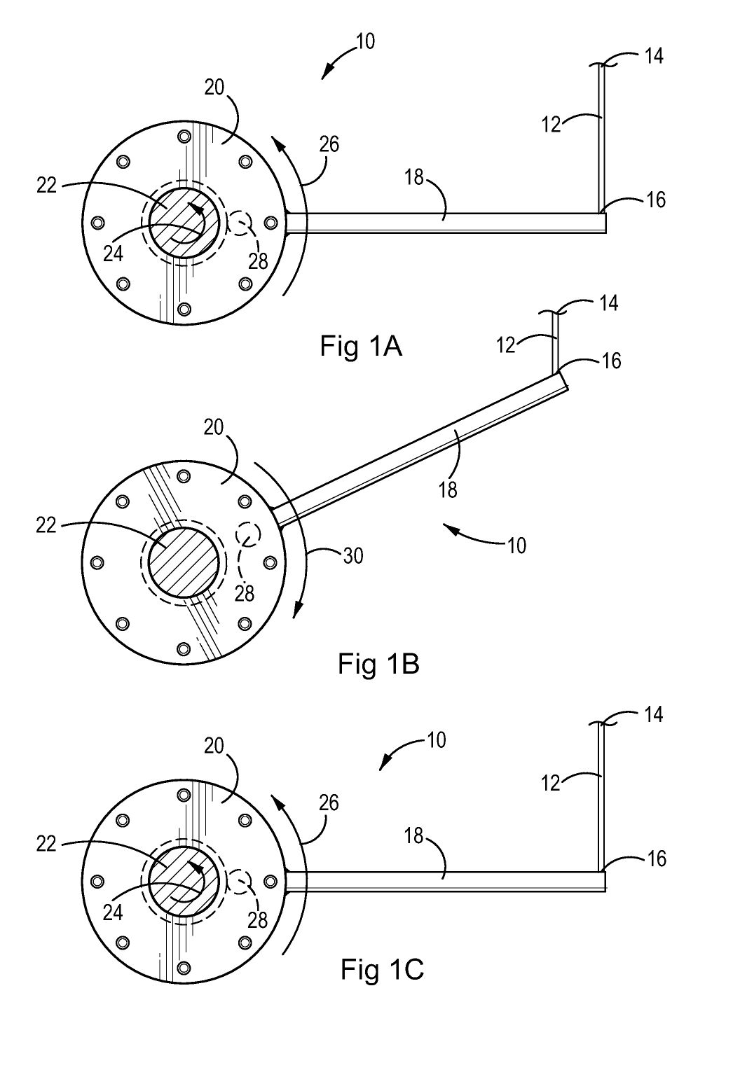

With reference to FIG. 1A, FIG. 1B and FIG. 1C of the drawings, reference numeral 10 generally denotes a wave buoy assembly at various stages in use in accordance with one aspect of the invention.

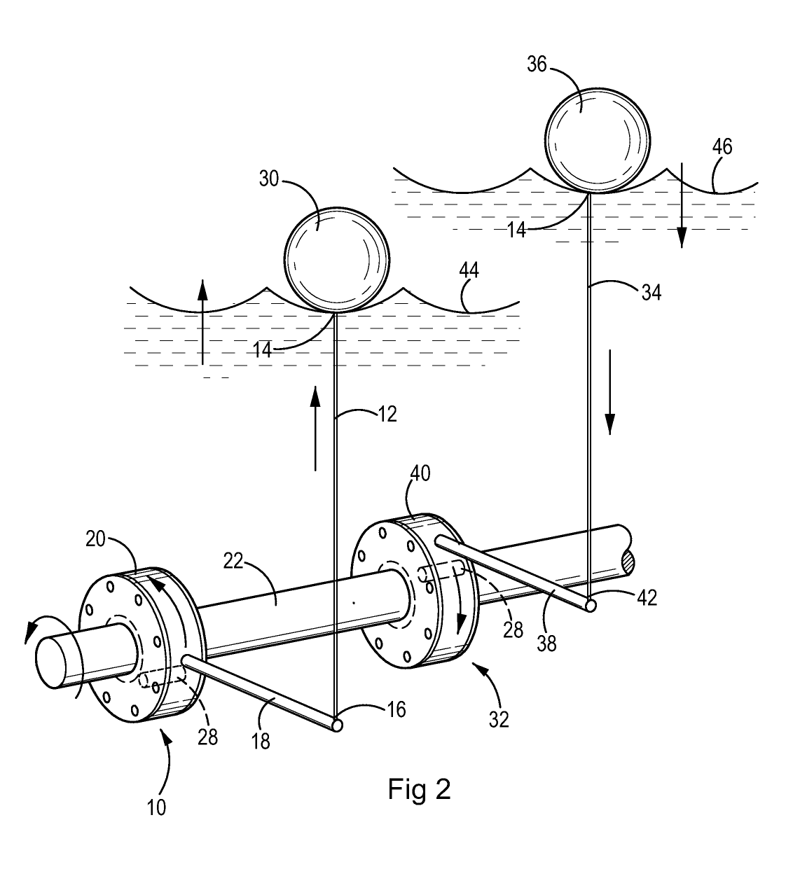

The wave buoy assembly 10 includes a tensile member in the form of a flexible cable 12 having an operatively upper end 14 and an operatively lower end 16, a buoy being attached to the upper end 16 (as will become clear in FIG. 2) of the cable. A torque lever in the form of a rigid elongate lever 18 is attached to the operatively lower end of the flexible cable 12 at one side, whilst the other side of the lever 18 is rigidly attached to a friction coupling 20 that defines a pivot and is annularly installed on a driveshaft 22 (not forming part of the assembly and shown here for illustrative purposes only) of a linear electrical generator.

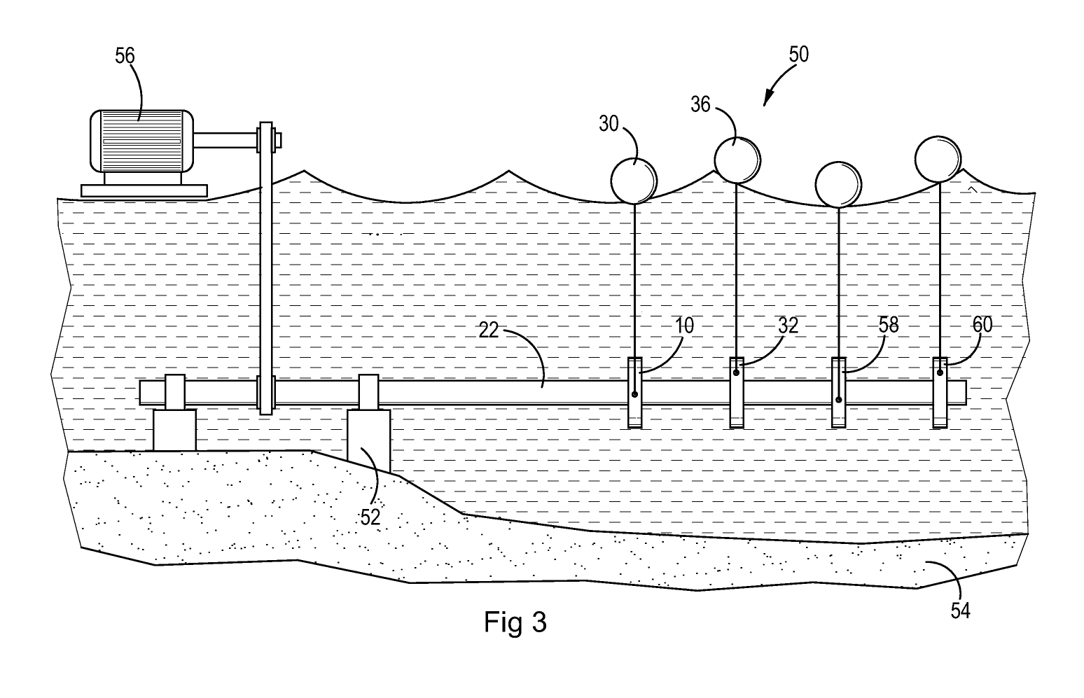

In this embodiment, the friction coupling 20 is an annular clutch in the form of a one-way free wheeling clutch, and specifically a one-way roller-type clutch rigidly connected to the lever 18. It should be noted that the driveshaft 22 is vertically stationary and supported by a rig on which it stands (as will become more apparent from FIG. 3). The clutch 20 allows engagement of the driveshaft 22 and rotation thereof only in an anti-clockwise direction as denoted by numeral 24.

In a first state of operation indicated by FIG. 1A, the tensile member, i.e. the flexible cable 12 is tensioned by the rise of a buoy connected at 14 through the rising of a water level, thus extorting an upwards force at the end 16 of the lever. The upwards force pivots the clutch 20 about the pivot, thereby causing the clutch 20 to engage with the driveshaft 22 and transferring an anti-clockwise force 26 to the driveshaft which turns the driveshaft 22 in an anti-clockwise direction 24. Engagement of the clutch 20 with the driveshaft 22 is illustrated by a roller 28 of the clutch 20 contacting the driveshaft 22.

FIG. 1B shows a second state of operation of the buoy assembly 10 wherein the buoy connected at 14 is lowered by a drop in the water level on which the buoy floats (see FIG. 2). The drop of the buoy releases tension of the cable 12, thereby removing the upwards pressure exerted on the lever 18 and allowing the lever to rotate clockwise 30 into a rested and relaxed position. The free wheeling clutch 20 allows disengagement of its roller 28 from the driveshaft 22 and allows the lever 18 to “slip”, thereby exerting no rotational force on the driveshaft 22.

FIG. 1C shows the start of the reputation of a cycle as described by FIGS. 1A and 1B, wherein the roller 28 of the clutch 20 is again engaged by an upwards force exerted on the lever 18 at 16 resulting from a rise in the buoy connected at 14.

Referring to FIG. 2 of the drawings, reference numeral 10 again generally denotes the buoy assembly of FIG. 1, installed on the driveshaft 22. In the figure, a buoy 30 of the assembly 10 is clearly shown. Alongside the assembly 10, another buoy assembly of the like 32 is installed on the same driveshaft 22, the buoy assembly 32 also including a buoy 36 attached to a tensile member in the form of a flexible cable 34, the cable 34 in turn attached to a torque lever in the form of a rigid elongate lever 38 at 42 and the lever 38 being attached to a one-way free wheeling clutch 40. In the figure, the driveshaft is vertically fixed and shown installed underwater at a coastline, the water level line indicated by numerals 44 and 46. In the case of the buoy assembly 10, the water line rising, causing the buoy 30 to rise and extort a tensile force on the lever 18 at its end 16. The clutch 20 is engaged with the driveshaft 22, and a rotational anti-clockwise force is transferred to the driveshaft causing it to turn anti-clockwise. In the case of the buoy assembly 32, the water level 46 drops with a corresponding lowering of the cable 34, thereby releasing any tensile force on the lever 38 and causing the clutch 40 to “slip” clockwise without rotating the driveshaft 22. Thus, whilst the assembly 10 advances the turn of the shaft 22, the assembly 32 merely awaits in rested readiness for a rise of its buoy 36 and exerts no counter-force on the shaft. Through many successive rotations of the shaft in this manner and by many more of the buoy assemblies of the like installed on the shaft (not shown), sufficient turning of the shaft is created to drive the generator shown in the installation of FIG. 3.

Referring now to FIG. 3 and reference numeral 50 that denotes a wave buoy assembly installation in accordance with another aspect of the invention. The installation 50 includes the driveshaft 20 of FIGS. 1 and 2 being installed on a rig 52 anchored to the seabed 54 at an offshore location. The driveshaft 22 is connected to an electrical generator 56 and in use, is driven by wave buoy assemblies 10 and 32 of FIG. 2 and an additional number of assemblies of which only two are indicated as 58 and 60.

Advantageously, a buoy assembly installation as hereinbefore described and implementing a plurality of buoy assemblies as described provides a simplified, low-maintenance mechanism of driving a power take-off system, such as an electrical generator.

What is claimed is:

1. A wave power buoy assembly which includes:
a tensile member having an operatively upper end and an operatively lower end;
a buoy attached to the operatively upper end of the tensile member;
a torque lever attached to the operatively lower end of the tensile member; and
a friction coupling defining a pivot, the friction coupling being rigidly connected to the torque lever for annular installation of the coupling on a driveshaft of an electrical generator.

2. A wave power buoy assembly as claimed in claim 1, wherein the tensile member is a cable.

3. A wave power buoy assembly as claimed in claim 1, wherein the torque lever is a rigid elongate lever having one end thereof attached to the operatively lower end of the tensile member and defining a pivot-end connected to the pivot of the friction coupling.

4. A wave power buoy assembly as claimed in claim 3, wherein the friction coupling is an annular clutch rigidly connected to the torque lever at the pivot-end of the rigid elongate lever.

5. A wave power buoy assembly as claimed in claim 4, wherein the annular clutch is a one-way free-wheeling clutch allowing operative of the driveshaft and rotation of the driveshaft in one direction only.

6. A wave power buoy assembly as claimed in claim 5, wherein the one-way free-wheeling clutch is a ramp and roller type clutch.

7. A wave power buoy assembly as claimed in claim 5, wherein the one-way free-wheeling clutch is a sprag and drawn cup roller type clutch.

8. A wave power buoy assembly as claimed in claim 1, wherein the friction coupling is a strap wrench mountable on the driveshaft.

9. A wave power buoy assembly as claimed in claim 8 wherein the strap wrench comprises a strap and a claw.

10. A wave power buoy assembly as claimed in claim 9 having a rigid retainer bar fixed to the strap wrench.

11. A wave power buoy assembly as claimed in claim 10, wherein the torque lever is defined by the rigid retainer bar.

12. A wave power buoy installation which includes:
an electrical generator driveshaft installed substantially horizontally at least partly underwater;
a plurality of wave power buoy assemblies as claimed in claim 3 installed on the driveshaft in a wave power buoy assembly array.

13. A wave power buoy installation as claimed in claim 12 which includes a power take-off system connected to the driveshaft.

14. A wave power buoy installation as claimed in claim 12, wherein the driveshaft is installed on a mounting rig.

15. A wave power buoy assembly as claimed in claim 2, wherein the torque lever is a rigid elongate lever having one end thereof attached to the operatively lower end of the tensile member and defining a pivot-end connected to the pivot of the friction coupling.

16. A wave power buoy assembly as claimed in claim 2, wherein the friction coupling is a strap wrench mountable on the driveshaft.

17. A wave power buoy installation as claimed in claim 13, wherein the driveshaft is installed on a mounting rig.

18. A wave power buoy installation which includes:
an electrical generator driveshaft installed substantially horizontally at least partly underwater;
a plurality of wave power buoy assemblies as claimed in claim 8 installed on the driveshaft in a wave power buoy assembly array.

19. A wave power buoy installation as claimed in claim 13, wherein the driveshaft is installed on a mounting rig.
